(19) United States
(12) Patent Application Publication
(10) Pub. No.: US 2022/0167021 A1
(43) Pub. Date: May 26, 2022

(54) Virtual Reality Viewing System

(71) Applicants: Edward French, Jersey City, NJ (US); Tamela Williams, Charlotte, NC (US)

(72) Inventors: Edward French, Jersey City, NJ (US); Tamela Williams, Charlotte, NC (US)

(21) Appl. No.: 17/384,069

(22) Filed: Jul. 23, 2021

Related U.S. Application Data
(60) Provisional application No. 63/118,284, filed on Nov. 25, 2020.

(51) Int. Cl. H04N 21/2187; H04N 21/414; H04N 21/41; H04N 21/258; G06F 3/01

(52) U.S. Cl. CPC H04N 21/2187; H04N 21/41407; G06F 3/013; H04N 21/25875; H04N 21/4126

(57) ABSTRACT

A virtual reality viewing system is disclosed that allows an individual to virtually attend a sporting event, concert or the like from a remote location. The virtual reality viewing system features a virtual reality headset that enables the user to view the live event in real-time through a digital hologram or avatar. Additionally, the virtual reality viewing system supports a corresponding smartphone application which enables the user to purchase a ticket to the live event and wirelessly connect to cameras within the even venue to simulate what the user would see and hear as if they were sitting in a seat at the event, in person. The novel virtual reality viewing system allows individuals to partake in live events from a remote location, saves both time and money on travel, parking, etc., and also enables individuals to properly social distance and reduce the risk of contracting an infectious disease.

### CROSS-REFERENCE TO RELATED APPLICATION

The present application claims priority to, and the benefit of, U.S. Provisional Application No. 63/118,284, which was filed on Nov. 25, 2020 and is incorporated herein by reference in its entirety.

### FIELD OF THE INVENTION

The present invention relates generally to the field of virtual reality. More specifically, the present invention relates to a virtual reality viewing system that allows an individual to virtually attend a sporting event, concert or the like while remaining at home or another remote location. The virtual reality viewing system features a virtual reality headset that enables the user to view the live event in real-time and virtually attend the event via a digital hologram or avatar. Additionally, the virtual reality viewing system supports a corresponding smartphone application which enables the user to purchase a ticket to the event and wirelessly connect to cameras and microphones within the stadium to simulate what the user would see and hear if they were attending the event in person. The novel virtual reality viewing system allows individuals to partake in live events from the privacy and safety of their homes, saves extensive amounts of time and money on travel, parking, etc., and also enables individuals to properly social distance and reduce the risk of contracting harmful germs, viruses, bacteria and the like. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, a pandemic is an epidemic of an infectious disease spread across a large region such as, for example, multiple continents or worldwide, and affects the lives of substantial number of people. Throughout human history, a number of pandemics, such as smallpox, tuberculosis, plague and others, have killed millions of people. Additionally, current pandemics, such as COVID-19, rapidly spread amongst the population and are dangerous to the lives of those that become infected. To prevent the spread of such infectious diseases, various healthcare professionals advise individuals to take a number of precautionary measures. For example, individuals are advised to maintain personal hygiene by frequently and thoroughly washing their hands, wear face masks when out in public areas, avoid touching of eyes, nose and mouth with hands, frequent cleaning and/or disinfecting of commonly touched surfaces, and more.

Apart from the above-mentioned precautionary measures, individuals are also advised to maintain proper social distancing to prevent the spread of harmful germs, viruses, or other pathogens, and therefore prevent the spread of infectious diseases. As per social distancing guidelines, individuals are oftentimes advised to avoid public spaces that are closed, crowded or that involve the close contact of individuals, such as large scale sporting events, concerts, shows, etc. Accordingly, many individuals avoid attending crowded events and concerts, as it may lead to the spread of infectious diseases. As a result, a smaller number of individuals may attend such events leading to the cancellation of the event for lack of sufficient revenue generation. Unfortunately, the cancellation of such events leads to lost revenue, business closures and overall disappointment by all involved.

Therefore, there exists a long felt need in the art for a virtual reality event viewing system that enables users to view events, concerts and the like from a remote location, but with the same look and feel as if they were physically present at the event, as opposed to watching the event on a television where the user has no control. Additionally, there is a long felt need in the art for a virtual reality event viewing system that enables users enjoy the live event without being exposed to infectious diseases that may be transmitted by others in attendance at the live event. Moreover, there is a long felt need in the art for a virtual reality event viewing system that enables event organizers to organize live events without the worry of losing their investment because of lack of participation in the time of a pandemic. Further, there is a long felt need in the art for a virtual reality event viewing system that saves the user extensive amounts of time and money that would otherwise be spent on travelling to and from the live event, parking, tolls, etc. if the event were attended in-person. Finally, there is a long felt need in the art for a virtual reality event viewing system that is relatively inexpensive to manufacture, and that is both safe and easy to use.

The subject matter disclosed and claimed herein, in one embodiment thereof, comprises a virtual reality viewing system designed for use with live events such as, but not limited to, sporting events, concerts, plays, operas, etc. where in person participation by the user may not be possible or desirable. The system is comprised of a virtual reality headset to be worn by the user; a smartphone application for purchasing tickets to the live event and for wirelessly connecting to an authorization server and the virtual reality headset; one or more hologram projectors to create holograms of the spectator; a plurality of cameras and speakers, wherein the hologram projectors, a plurality of cameras and speakers are placed at the venue of the live event and the virtual reality headset is in wireless communication with the cameras and speakers to enable the user to view the live event virtually. The system uses virtual and augmented reality devices working together and combining different user interfaces, interaction models, input methods, peripherals and applications to allow users to attend large scale events during a pandemic without sacrificing their personal safety.

In this manner, the novel virtual reality viewing system of the present invention accomplishes all of the forgoing objectives, and provides a relatively convenient, safe and cost-effective solution to viewing live events from a remote location, wherein the user can experience the look and feel of the live event without risking their safety or enduring the other inconveniences associated with attending the event in person. The virtual reality event viewing system of the present invention is also user friendly, inasmuch as it is less expensive than attending the event in person, and prevents the transmission of germs, viruses and other harmful pathogens, while ensuring the safety of people from the spread of diseases.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

As stated above, the subject matter disclosed and claimed herein, in one embodiment thereof, comprises a virtual reality viewing system designed to enable a user to attend a live event such as, but not limited to, a sporting event, concert, play, opera, etc. virtually where in person participation by the user may not be possible or desirable. The system is comprised of a virtual reality headset to be worn by the user; a smartphone application for purchasing tickets to the live event and for wirelessly connecting to an authorization server; one or more hologram projectors to create holograms of the user at the live event; and a plurality of cameras and speakers placed at the live event, wherein the virtual reality headset is in wireless communication with the cameras and speakers to enable the user to view and hear the live event virtually.

In a further embodiment of the present invention, a method for providing a virtual experience of a live event to a spectator is disclosed. The method comprises the steps of a spectator purchasing a ticket to a live event using a smartphone application or online through a website, and authorizing the spectator to connect to an augmented reality/virtual reality system. Next, the spectator wirelessly connects an augmented reality/virtual reality headset worn by the spectator to the one or more cameras, speakers, microphones, etc. present at the venue of the live event, and a hologram of the spectator is created and is visible to the viewing media and the athletes or entertainers giving the performance. Finally, the spectator uses the augmented reality/virtual reality headset to view and participate in the live event remotely, and without the risk of contracting an infectious disease.

In yet a further embodiment of the present invention, a system for enabling a user to experience a live event virtually on an augmented reality/virtual reality headset (AR/VR headset) is disclosed. The system comprises the AR/VR headset, a plurality of high resolution cameras to capture video of the live event, noise cancellation speakers to capture audio of the live event, a plurality of hologram projectors to project holograms or avatars of the various spectators watching the event from home through the wearable AR/VR headset, a video processing server to process the captured video and audio, and a server to transmit the processed video and audio content through a high speed network (e.g., a 5G network) to the AR/VR headset for virtual interaction of the spectator wearing the AR/VR headset with the live event.

In yet another embodiment of the present invention, a AR/VR headset that is designed to enable a user to remotely and virtually interact with a live event is disclosed. The AR/VR headset is comprised of a processor, a wireless network module to wirelessly connect to a server or any other wireless device, a plurality of microphones to capture wearer's audio, a speaker to emit sounds of the live event viewed on a display of the AR/VR headset, and a plurality of control buttons to control the operation of one or more components of the AR/VR headset. In a further embodiment, the various components of the AR/VR headset can be controlled by the user via a paired smartphone application.

The system of the present invention provides users with a virtual reality event viewing system, allowing for sporting events, concerts and the like to be held as people purchase tickets to attend from home. The arena, stadium, or event which the person has paid to view may be filled with “holograms” of the virtual attendants projected by the hologram projectors, which are visible to the viewing media and the athletes or entertainers giving the performance. The system saves extensive amounts of time and money typically associated with attending a live event in person including, without limitation, travel cost, parking, tools, etc. Further, the system further keeps individuals safe by allowing them to attend the event remotely and virtually, thereby reducing the spread of harmful germs, viruses, bacteria and the like. The system makes use of the developing 5G networks to maintain seamless connection while attending the event virtually.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of one potential embodiment of the virtual reality viewing system of the present invention in accordance with the disclosed architecture;

FIG. 2 illustrates a perspective view of the essential components of one potential embodiment of the virtual reality viewing system of the present invention in accordance with the disclosed architecture;

FIG. 3 illustrates a flow chart showing the main steps of one potential embodiment of the method of using the virtual reality viewing system of the present invention in accordance with the disclosed architecture;

FIG. 4 illustrates a perspective view of one potential embodiment of the hologram component of the virtual reality viewing system of the present invention in accordance with the disclosed architecture, wherein the hologram component is being used to create a hologram or avatar of the spectator at the live event;

FIG. 5 illustrates a perspective view of the essential components of one potential embodiment of the AR/VR headset of the virtual reality viewing system of the present invention in accordance with the disclosed architecture;

FIG. 6 illustrates a perspective view of a user using the mobile application of the virtual reality viewing system of the present invention to purchase virtual attendance at the live event in accordance with the disclosed architecture;

FIG. 7 illustrates a perspective view of the user of FIG. 6 wearing one potential embodiment of the AR/VR headset of the virtual reality viewing system of the present invention to virtually and remotely participate in the live event in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a virtual reality event viewing system that enable a user to virtually participate in a live event from a remote location, but with the same look and feel as if they were present at the live event. Additionally, there is a long felt need in the art for a virtual reality event viewing system that enables the user to enjoy the live event without being exposed to an infectious disease that may be transmitted by others in attendance at the live event. Moreover, there is a long felt need in the art for a virtual reality event viewing system that enables event organizers to organize live events without the worry of losing their investment because of the lack of participation at the event, for example, during a time of a pandemic. Further, there is a long felt need in the art for a virtual reality event viewing system that saves the user extensive amounts of time and money that would otherwise be spent on travelling to and from the live event, parking, tolls, etc. if the event were attended in-person. Finally, there is a long felt need in the art for a virtual reality event viewing system that is relatively inexpensive to manufacture, and that is both safe and easy to use

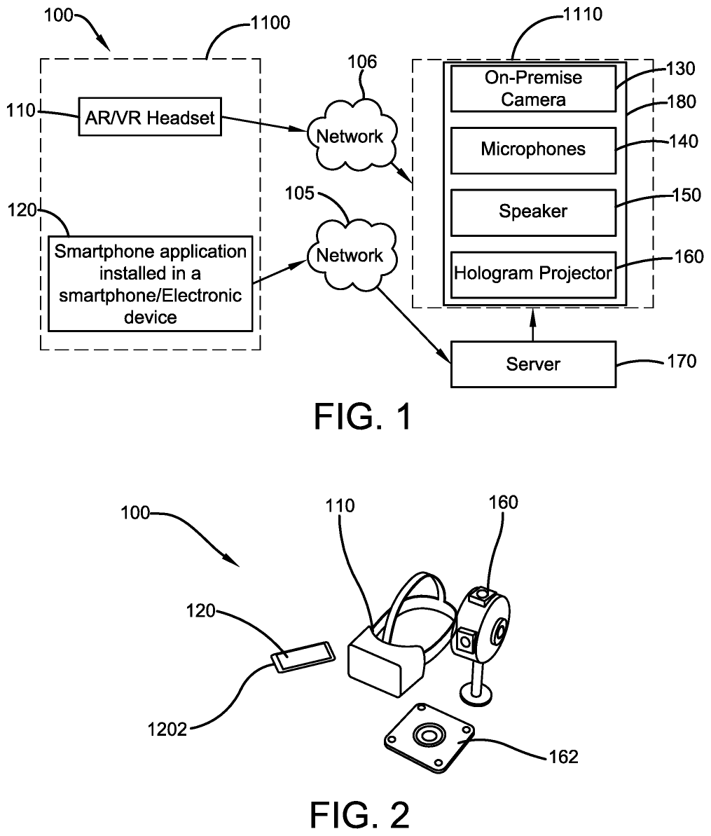

Referring initially to the drawings, FIG. 1 illustrates a schematic diagram of one potential embodiment of the virtual reality viewing system 100 of the present invention in accordance with the disclosed architecture. As illustrated, the system 100 is comprised of an Augmented Reality/Virtual Reality headset (AR/VR headset) 110 and a mobile application 120 installed on a smartphone or other electronic device 1202, such as a tablet, computer, etc. Both the AR/VR headset 110 and the smartphone application 120 installed on a smartphone/electronic device 1202 should be with the virtual spectator 600 at an audience location 1100 where the spectator 600 will virtually attend the live event using the system 100 such as, but not limited to, a residence, office or other remote location. Alternatively, the smartphone application 120 may be installed directly on the AR/VR headset 110.

The mobile application 120 can be downloaded from any mobile application store, such as Google PlayStore, Apple Store, etc. Once the mobile application 120 has been downloaded onto the device 1202, the user/virtual spectator 600 can create a profile within the application 120 and can also proceed to purchase one or more tickets to a plurality of available live events such as, but not limited to, sporting events, concerts, plays, operas, etc. and regardless of the geographic location of the live event. For example, the live event may be anywhere in the world. The user 600 can also save payment information and other important details and preferences within the mobile application 120 for future use. The mobile application 120 is wirelessly connected to a ticket server 170 through a network 105, 106 which can be a public or a private network. The server 170 along with a payment server (not shown) then authorizes the payment and stores the purchase information (i.e., ticket number, event date, type of seat, etc.) of the user 600. In one embodiment of the present invention, an avatar or hologram 402 can be chosen by the user through the mobile application 120 at the time of purchase by, for example, using an uploaded image of the user 600, or the user 600 can simply select a hologram 402 from an existing database of avatars/holograms 402 at any time.

During the live event, the AR/VR headset 110 is worn by the virtual spectator 600 and is in wireless communication with a plurality of components of the system 100 that are physically present at the venue 1110 of the live event including, without limitation, one or more cameras 130, microphones 140, speakers 150 and hologram projectors 160, through an application server 180 or through any other mechanism known in the art, and via a cloud based network 106. In a preferred embodiment of the system 100, the network 106 is a 5G NR network. However, it should be appreciated that any other telecommunication technology enabling a user to view and participate in the live event using the AR/VR headset 110 and the various components 130, 140, 150, 160 present at the venue 1110 can be used in accordance with the present invention.

In order for the spectator 600 to view and remotely participate in the live event, the spectator 600 must first use the mobile application 120 to authenticate him or herself with the server 170 and then wirelessly connect the AR/VR headset 110 to the various components 130, 140, 150, 160 present at the venue 1110. In one embodiment of the present invention, the smartphone/electronic device 1202 with the mobile application 120 loaded thereon remains connected to the AR/VR headset 110 through a wireless connection such as, but not limited to, Wi-Fi, cellular, Bluetooth, etc. for authentication of the AR/VR headset 110 via the server 170. For the avoidance of doubt, during the entirety of the live event, the audience location 1100 is geographically remote from the venue 1110 and could be, for example, on the other side of the country or even the world.

FIG. 2 illustrates a perspective view of the essential components of one potential embodiment of the virtual reality viewing system 100 of the present invention in accordance with the disclosed architecture. As shown, the AR/VR headset 110, the hologram projector 160, and the mobile application 120 installed on the electronic device 1202 are required for the system 100 of the present invention to work efficiently. As stated earlier, high resolution cameras 130, microphones 140 and speakers 150 are also present at the venue 1110 and are utilized to capture the images and sounds of the live event and wirelessly transmit the same to the AR/VR headset 110 at the audience location 1100.

In one embodiment of the system 100 of the present invention, in addition to the spectator 600 watching the live event on the AR/VR headset 110, a life-like hologram of the spectator 600 may also be shown in the stadium/arena/venue 1110 using one or more hologram projectors 160, 162 positioned at the venue 1110. In fact, the arena, stadium or venue 1110 may be filled with holograms 402 of the virtual attendants using the hologram projectors 160, 162 which will be visible to the viewing media and the athletes or entertainers to provoke the same to give a more inspired performance. It is also contemplated that the venue 1110 could be filled with a combination of holograms 402 and live attendees, thereby making it easier for those in live attendance to socially distance from one another.

It is also contemplated that the various components of the system 100 positioned at the venue 1110 may also be used to stream live video and audio of the event to those watching the event on a television or other electronic device without the benefit of the AR/VR headset 110. Additionally, through the AR/VR headset 110, the spectator 600 can teleport to different camera positions around the stadium/arena 1110, to see the performance from different perspectives. The virtual reality viewing system 100 also captures the live sounds of the remote participants 600 and can relay the same through the speakers 150 present at the venue 1110 in a coherent manner. In the preferred embodiment of the present invention, the virtual reality system 100 supports commercially available AR/VR headsets of multiple companies such as, but not limited to, Samsung Gear VR platform, Oculus Go, etc. Further, in one embodiment, the mobile application 120 may be present on the AR/VR headset 110 itself, such that a separate electronic device 1202 is not required to operate the system 100 of the present invention.

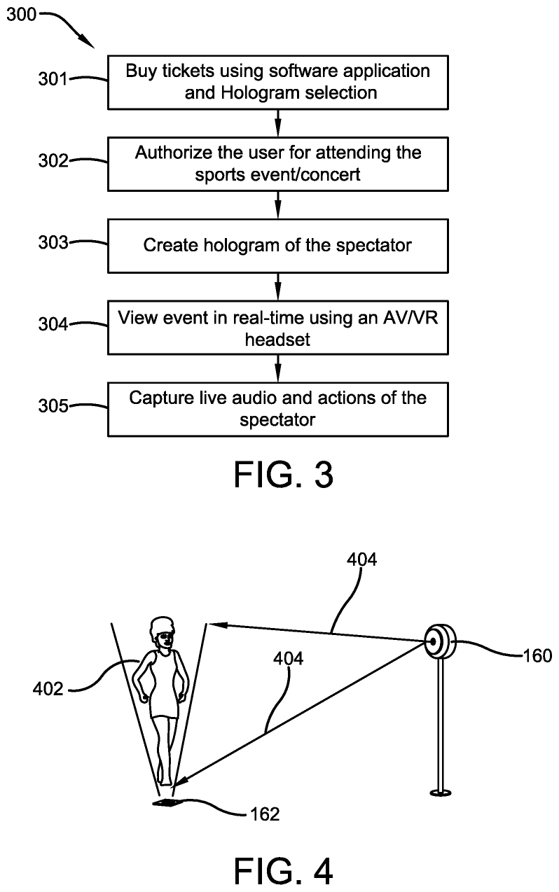

FIG. 3 illustrates a flow chart showing the main steps of one potential embodiment of the method of using the virtual reality viewing system 100 of the present invention in accordance with the disclosed architecture. For example, at block 301, a virtual spectator 600 purchases a ticket to a live event anywhere in the world using the mobile application 120 and optionally also selects a hologram 402. The spectator 600 may also gift tickets to the event to his or friends and/or family through the mobile application 120. Next, at block 302, the spectator 600 is authorized to virtually attend the live event through the AR/VR headset 110 by verifying the purchased ticket and other credentials of the spectator 600 by a server 170 of the system 100.

After authorization of the spectator 600, the hologram 402 is created of the user/spectator using the hologram projectors 160, 162 present at the stadium/arena 1110 at block 303. Then, when the live event begins, the spectator 600 starts viewing the event in real-time using the AR/VR headset 110 at block 304. The AR/VR headset 110 has controls thereon which the spectator 600 can use to enhance or modify the experience (e.g., pan view, audio controls, zoom view, etc.). In addition, or alternatively, the experience can be controlled through the electronic device 1202 using the mobile application 120. In either event, the AR/VR headset 110, which is in wireless communication with each of the on-premises cameras 130, microphones 140 and speakers 150, captures live audio and video of the live event, and the actions of the spectator 600 are reflected in the hologram 402 of the spectator 600 exhibited at the venue 1110 at block 305. In fact, the arena or stadium 1110 may be filled with holograms 402 of the various spectators 600 which are visible to the viewing media and the athletes or entertainers.

The AR/VR headset 110 used in the present invention may also have additional functionalities such as, but not limited to, eye tracking to track the eyes of the spectator and accordingly display the field of arena to the spectator 600 via the on-premises cameras 130 and the AR/VR headset 110. The headset 110 also has a microphone and a speaker to provide the spectator 600 with live audio from the venue 1110, and to provide the spectator's audio to the speakers 150 positioned at the venue 1110. In one embodiment, the AR/VR headset 110 has gesture recognition that can be reflected in the hologram 402 of the spectator 600 at the venue 1110.

FIG. 4 illustrates a perspective view of one potential embodiment of the hologram component of the virtual reality viewing system 100 of the present invention in accordance with the disclosed architecture, wherein the hologram component is being used to create a hologram or avatar 402 of the spectator 600 at the venue 1110. More specifically, the stadium or arena 1110 is equipped with hologram projectors 160, 162 in wireless communication with the AR/VR headset 110 and/or the mobile application 120 to create a hologram 402 for each spectator 600 who purchased a ticket to the live event. In one embodiment, a main hologram projector 160 is used with a secondary hologram projector 162 to create a lifelike hologram 402 of each spectator 600, wherein a plurality of light beams rays 404 may be used to create the hologram 402.

More specifically, the hologram 402 of the present invention is an autonomous three-dimensional image formed by the interference of light beams 404 from a laser or other coherent light source 160, 162. The hologram 402 is like a free-floating image, wherein the spectator 600 gets the chance to see themselves in the live video of the event while attending the event from home. In one embodiment, the AR/VR headset 110 may have holographic computers that allow the spectator wearing the headset to see, hear, and interact with the high-definition holograms 402 within a controlled environment. It should be appreciated that the holograms 402 used in the present invention enhance spectator engagement. The event can include various physical spectators, and some beamed in via hologram 402. The invention delivers lifelike holograms 402 that give a sense of presence in the stadium/arena 1110, while keeping the spectator 600 safe by attending the event at home, and thus reducing the spread of harmful germs, viruses, infectious diseases and the like. The virtual reality viewing system 100 of the present invention can be integrated into any stage, auditorium, conference room or the like where the audience can virtually see, hear and interact in real-time with the event, thereby eliminating the challenges of time and distance. The virtual reality viewing system 100 can also be used for university lectures, international conferences, political events, trade shows and the like.

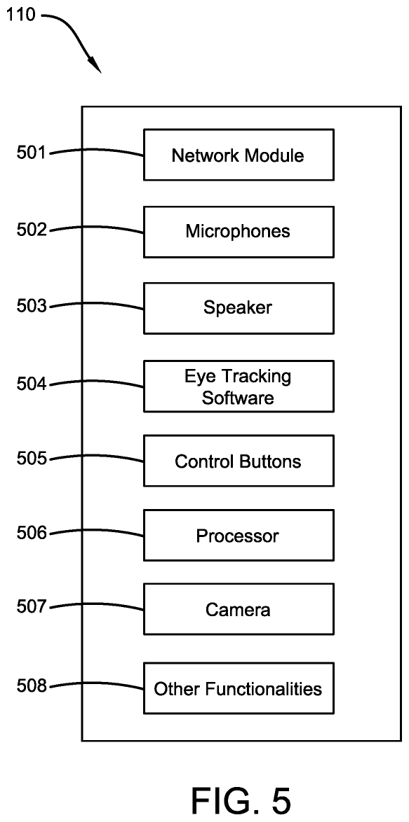

FIG. 5 illustrates a perspective view of the essential components of one potential embodiment of the AR/VR headset 110 of the virtual reality viewing system 100 of the present invention in accordance with the disclosed architecture. The AR/VR headset 110 is preferably comprised of a wireless network module 501 with 5G capability to wirelessly connect to a server and other on-premise devices for live viewing of the event. The AR/VR headset 110 further comprises one or more microphones 502 to capture the voice of the spectator 600, and a camera 507 to capture the image of the spectator 600 for creation of the real time hologram 402. Additionally, the AR/VR headset 110 also comprises one or more speakers 503 to play the sounds of the arena or stadium 1110 that are captured by the microphones 140 present at the venue 1110 and transmitted to the AR/VR headset 110 via the network(s) 105, 106.

Additionally, in a preferred embodiment, the AR/VR headset 110 also comprises one or more touch based or physical control buttons 505 to control and customize the view/audio of the live event that the spectator 600 is enjoying. Eye tracking software 504 may also be present to allow the spectator 600 to use his or her eyes to change the view of the event being relayed to the AR/VR headset 110 from the cameras 130 present at the venue 1110. Further, a processor 506 controls the operation of all of the various components of the AR/VR headset 110. More specifically, the processor 506 sends instructions to the various components to execute the operation. A buffer memory may also be present in the AR/VR headset 110 to store essential information, and also video and audio data. It should be noted that in addition to the modules or components described in the present embodiment, any additional functionality or modules to increase the efficiency and utility of the present invention may also be included.

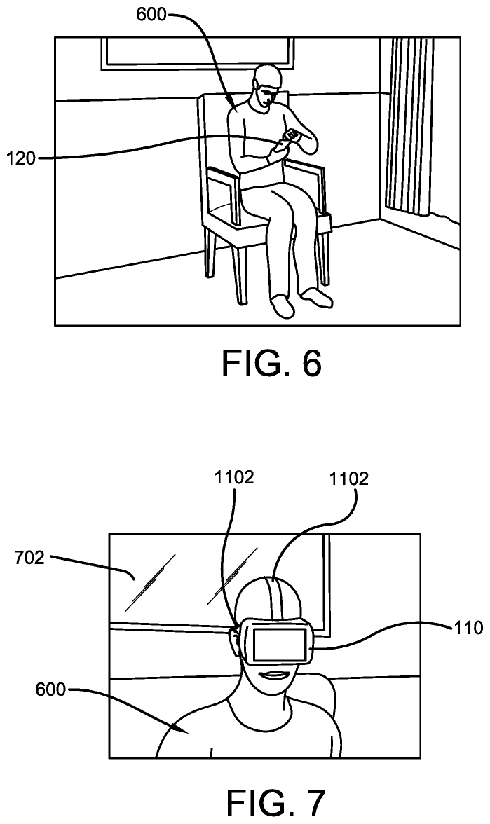

FIG. 6 illustrates a perspective view of a spectator 600 using the mobile application 120 of the virtual reality viewing system 100 of the present invention to purchase virtual attendance at the live event in accordance with the disclosed architecture. More specifically, a spectator 600 can connect to the virtual reality event viewing system 100 of the present invention by logging into the smartphone application 120. After a successful login, the spectator 600 can purchase one or more tickets, change seats and other preferences. The login also provides the spectator 600 with access to the live event via the AR/VR headset 110 and the mobile application 120.

FIG. 7 illustrates a perspective view of the user of FIG. 6 wearing one potential embodiment of the AR/VR headset 110 of the virtual reality viewing system 100 of the present invention to virtually and remotely participate in the live event in accordance with the disclosed architecture. More specifically, to view the live event, the AR/VR headset 110 is secured around the head of the spectator 600 with bands 1102 and is in wireless communication with the various other components of the virtual reality viewing system 100 of the present invention. The spectator 600 may then experience and interact with the live event in real time through his or her digital hologram or avatar 402.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “the virtual audience viewing system”, “virtual reality event viewing system”, and “the system” are interchangeable and refer to the virtual reality viewing system 100 of the present invention.

Notwithstanding the forgoing, the virtual reality viewing system 100 of the present invention and its various components can be of any suitable size and configuration as is known in the art without affecting the overall concept of the invention, provided that the same accomplish the above stated objectives. One of ordinary skill in the art will appreciate that the size, shape and/or configuration of any component of the virtual reality viewing system 100 as shown in the FIGS. are for illustrative purposes only, and that many other sizes, shapes and/or configurations and components of the virtual reality viewing system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A virtual reality viewing system comprising:
an AR/VR headset;
a mobile application in wireless communication with the AR/VR headset;
a network; and
a plurality of electronic components positioned at a venue that is geographically remote from each of the AR/VR headset and the mobile application.

2. The virtual reality viewing system as recited in claim 1, wherein the AR/VR headset comprises a network module, a microphone, and a speaker.

3. The virtual reality viewing system as recited in claim 2, wherein the AR/VR headset further comprises a camera and a processor.

4. The virtual reality viewing system as recited in claim 3, wherein the AR/VR headset further comprises an eye tracking software.

5. The virtual reality viewing system as recited in claim 4, wherein the plurality of electronic components comprise an on-premises camera, an on-premises microphone and an on-premises speaker.

6. The virtual reality viewing system as recited in claim 5, wherein the plurality of electronic components comprise a main hologram projector.

7. The virtual reality viewing system as recited in claim 6, wherein the plurality of electronic components comprise a secondary hologram projector.

8. The virtual reality viewing system as recited in claim 7, wherein each of the main and the secondary hologram projectors is in wireless communication with the AR/VR headset.

9. The virtual reality viewing system as recited in claim 8, wherein the network is cloud based.

10. The virtual reality viewing system as recited in claim 1, wherein the plurality of electronic components are in wireless communication with the AR/VR headset.

11. The virtual reality viewing system as recited in claim 1, wherein the AR/VR headset further comprises at least one head strap for attaching the AR/VR headset to a head of a user.

12. The virtual reality viewing system as recited in claim 1, wherein the mobile application is installed on the AR/VR headset.

13. The virtual reality viewing system as recited in claim 1, wherein the mobile application is installed on an electronic device.

14. The virtual reality viewing system as recited in claim 13, wherein the electronic device is a smartphone.

15. A method of using a virtual reality viewing system to participate in a remote and live event comprising:
using a mobile application to purchase a ticket to the remote and live event;
creating a hologram of a spectator;
authorizing the spectator to participate in the remote and live event via a server;
installing a AR/VR headset of the virtual reality viewing system on the spectator at a start time of the remote and live event;
using a hologram projector positioned at the remote and live event to display the hologram at the remote and live event;
using a microphone and a camera positioned at the remote and live event to capture an audio and a video of the remote and live event; and
transmitting the captured audio and video of the remote and live event to the spectator via the AR/VR headset in real time.

16. The method of using a virtual reality viewing system as recited in claim 15, wherein the AR/VR headset comprises a network module, a microphone, and a speaker.

17. The method of using a virtual reality viewing system as recited in claim 16, wherein the AR/VR headset further comprises a camera and a processor.

18. The method of using a virtual reality viewing system as recited in claim 17, wherein the AR/VR headset further comprises an eye tracking software.

19. A virtual reality viewing system comprising:
an AR/VR headset having a network module, a microphone, a speaker, a camera, a processor, and an eye tracking software;
a mobile application in wireless communication with the AR/VR headset;
a server; and
a plurality of electronic components that are geographically remote from each of the AR/VR headset and the mobile application, wherein the plurality of electronic components comprise an on-premises camera and an on-premises microphone.

20. The virtual reality viewing system as recited in claim 19, wherein the plurality of electronic components further comprise a plurality of hologram projectors.
